(19) United States
(12) Patent Application Publication
(10) Pub. No.: US 2017/0175956 A1
(43) Pub. Date: Jun. 22, 2017

(54) BACKLIGHT MODULES

(71) Applicant: AU Optronics Corporation, HSIN-CHU (TW)

(72) Inventors: Chi-Sheng CHANG, Hsin-Chu (TW); Su-Yi LIN, HSIN-CHU (TW)

(21) Appl. No.: 14/971,543

(22) Filed: Dec. 16, 2015

(51) Int. Cl. F21V 9/16

(52) U.S. Cl. CPC F21K 9/64

(57) ABSTRACT

A backlight module is provided, which includes a plurality of single color light-emitting diodes (LEDs), an optical control film and a plurality of wavelength converting layers. The display panel includes a substrate and circuit elements. The optical control film having a plurality of through holes and being located above the plurality of single color LEDs. The plurality of wavelength converting layers disposed between the optical control film and the plurality of single color LEDs, wherein each of the wavelength converting layers corresponds to one of the single color LEDs and converts a light emitted from the one of the single color LEDs to white light.

### BACKGROUND OF THE DISCLOSURE

1. Field of the Disclosure

The present disclosure relates to a backlight module, and more particularly to a backlight module having a plurality of wavelength converting layers disposed between the optical control film and the plurality of single color LEDs.

2. Description of the Related Art

In recent years, as electronic products become more and more prevailing, display panels that provide the display function for the electronic products have come into focus among product designers. There are various types of display panel available according to the designs and need of the electronic products. Some of the display panels are provided with a self light-emitting function, and some of them are not. For the display panel without a self light-emitting function, a backlight module is needed for providing light to the display panel.

Backlight modules may be categorized into two types, which are a direct type backlight module and a edge type backlight module. The backlight module may use a variety of types of optical film, such as a prism film, a diffusion film, a brightness enhancement film (BEF), and other suitable optical films.

FIG. 1 is a schematic diagram of a conventional direct type backlight module. In order to improve the Mura phenomenon, i.e., non-uniform brightness distribution, of the display device that uses a backlight module, the backlight module may use an optical control film 101 to adjust the transmission path and distribution of the light emitted by the light source 102. The optical control film 101 has a plurality of through holes 103, and the number or area of the holes differs between different regions so as to differentiate the light transmission amounts in these regions. For example, fewer or smaller holes are formed in a region of the optical control film 101 corresponding to the top of the light source 102, so as to reduce the light transmission amount. Accordingly, the light 104 emitted by the light source 102 first passes through the optical control film 101 for adjusting the distribution profile before being transmitted outward, by which the uniformity of the light is improved.

In addition, for the backlight module to achieve wide color gamut (WCG), the backlight module may use blue light emitting diodes (LED) accompanied with a quantum dot enhancement film (QDEF) 105. The quantum dot enhancement film 105 converts part of the light emitted by the light source 102 into a light having a different wavelength. For example, partial blue light is converted into a yellow light, and then the two lights having different wavelengths are mixed to produce a white light. Due to the optical control film 101 disposed in the backlight module, there is more light reflection between the QDEF 105 and the region with fewer holes of the optical control film 101 (i.e., the region corresponding to the top of the light source). As a result, in the region above the light source 102, more light is converted into the yellow light, which causes the overall light-emitting color of the backlight module to be non-uniform, and this phenomenon is called color shift.

### SUMMARY OF THE DISCLOSURE

In one embodiment, the present disclosure provides a backlight module includes: a plurality of single color light-emitting diodes (LEDs); an optical control film having a plurality of through holes, the optical control film being located above the plurality of single color LEDs, and a plurality of wavelength converting layers disposed between the optical control film and the plurality of single color LEDs, wherein each of the wavelength converting layers corresponds to one of the single color LEDs and converts a light emitted from the one of the single color LEDs to white light.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic diagram of a conventional direct type backlight module;

FIG. 2 is a schematic side view of a backlight module according to an embodiment of the disclosure;

FIG. 3 is a is a schematic side view of a converting layer according to an embodiment of the disclosure;

FIG. 4 is a schematic side view illustrating a part of FIG. 2;

FIG. 5 is a schematic top view of optical control film and wavelength converting layer.

FIG. 6 is a schematic side view of a optical control film according to an embodiment of the disclosure;

FIGS. 7 and 8 are schematic side views illustrating the relative dimension relationship among some of the elements of a backlight module according to two different embodiments of the disclosure; and

FIGS. 9A and 9B illustrate an optical control film covered by a wavelength converting layer according to two different embodiments of the disclosure.

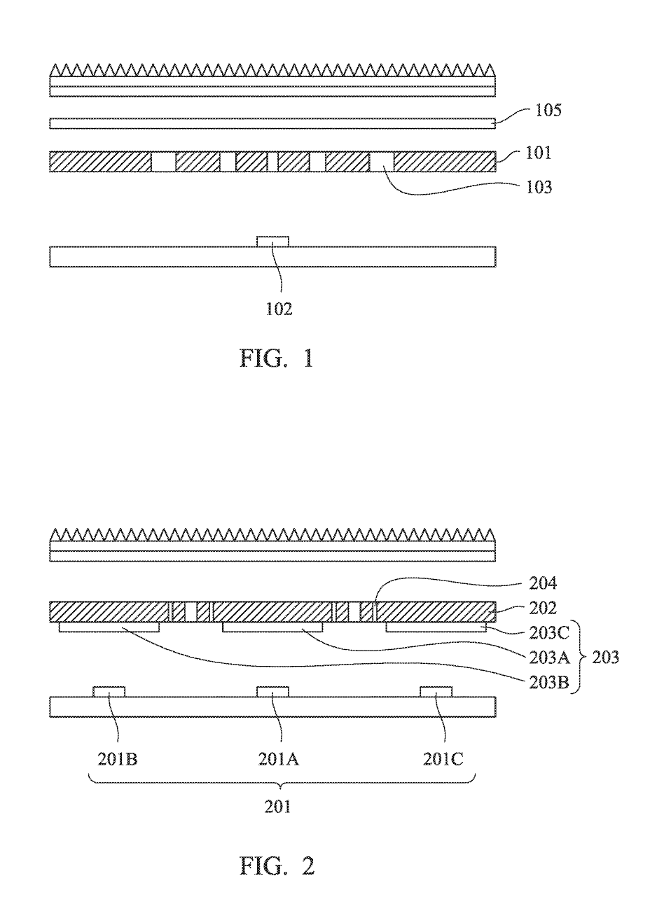

### DESCRIPTION OF THE ILLUSTRATED EMBODIMENTS

The present disclosure will now be described in detail with reference to the accompanying drawings, wherein the same reference numerals will be used to identify the same or similar elements throughout the several views. It should be noted that the drawings should be viewed in the direction of orientation of the reference numerals.

FIG. 2 is a schematic side view illustrating a backlight module according to an embodiment of the disclosure. As shown in FIG. 2, in an embodiment, a backlight module 20 comprises a plurality of single color light-emitting diodes (LEDs) 201, an optical control film 202 and a plurality of wavelength converting layers 203. The optical control film 202 has a plurality of through holes 204, and the optical control film 202 is located above the plurality of single color LEDs 201. The plurality of wavelength converting layers 203 are disposed between the optical control film 202 and the plurality of single color LEDs 201. In an embodiment, each of the wavelength converting layers 203 corresponds to one of the single color LEDs 201 and converts a light L emitted from the one of the single color LEDs 201 to white light. In an embodiment, as shown in FIG. 2, the wavelength converting layer 203A corresponds to the single color LED 201A and converts a light LA emitted from the single color LED 201A to white light, the wavelength converting layer 203B corresponds to the single color LED 201B and converts a light LB emitted from the single color LED 201B to white light, and the wavelength converting layer 203C corresponds to the single color LED 201C and converts a light LC emitted from the single color LED 201C to white light. In an embodiment, the light LA, LB and LC have the same light color such as blue light, and all the converting layer 203A, 203B and 203C convert blue light to white light.

In another embodiment, the light colors of the light LA, LB and LC can be different from each other, or at least two of them are different from each other. For example, the light color of light LA can be blue light, the light color of light LB can be green light, and the light color of light LC can be red light. In an embodiment, the converting layer 203A converts the blue light to white light, the converting layer 203B converts the green light to white light, and the converting layer 103C converts the red light to white light.

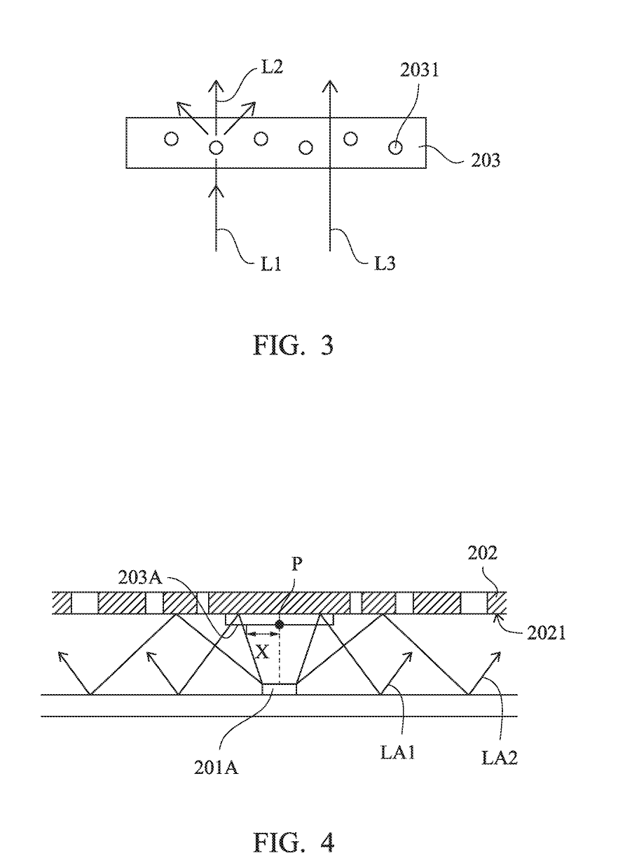

FIG. 3 is a schematic side view illustrating the converting layer 203. In an embodiment, the converting material disposed in the converting layer 203 is quantum dot (QD) 2031. That is, the converting layer 203 is a quantum dot layer. In the case that the light L is blue light, part of the blue light L1 of the light L is converted to yellow light L2 and part of the blue light L3 of the light L is not converted. As a result, the yellow light L2 mixes with the blue light L3, thereby generating white light.

FIG. 4 is a schematic side view illustrating part of the FIG. 2. As shown in FIG. 4, in an embodiment, the optical control film 202 has a reflective surface 2021 facing a light emitting side 2011 of the plurality of single color LEDs 201. As shown of FIG. 3, a light LA1 emitted from the single color LEDs 201A passes through the converting layer 203A and is reflected by the reflected surface 2021. A light LA2 emitted from the single color LEDs 201A is directly reflected by the reflected surface 2021. Accordingly, the light L emitted from the single color LEDs 201 can be repeatedly reflected by the reflective surface 2021 before passing through holes 204. The light L can be converted and mixed up to a uniformly white light before passing the optical control film 202.

In an embodiment, the concentration of the quantum dot 2031 within an entire corresponding one of the wavelength converting layers 203A is uniform. In another embodiment, the concentration of the quantum dot 2031 in the wavelength converting layers 203A is decreased along an increase of a distance X away from a point P of the wavelength converting layers 203A directly above the single color LED 201A. In an embodiment, the largest light density is directly above the center of LED, the largest concentration of the quantum dot 2031 is directly above the single color LED 201A, and the wavelength converting layers 203A can properly convert the light emitted from the single color LED 201A to white light. In another embodiment, because the largest light density is directly above the center of LED, in order to produce a uniformly white light, the transmittance of the wavelength converting layer 203A directly above the single color LED 201A is the smallest. That is, the farther a distance X away from the point of the wavelength converting layer 203A directly above the single color LED 201A, the higher a transmittance of the wavelength converting layer 203A.

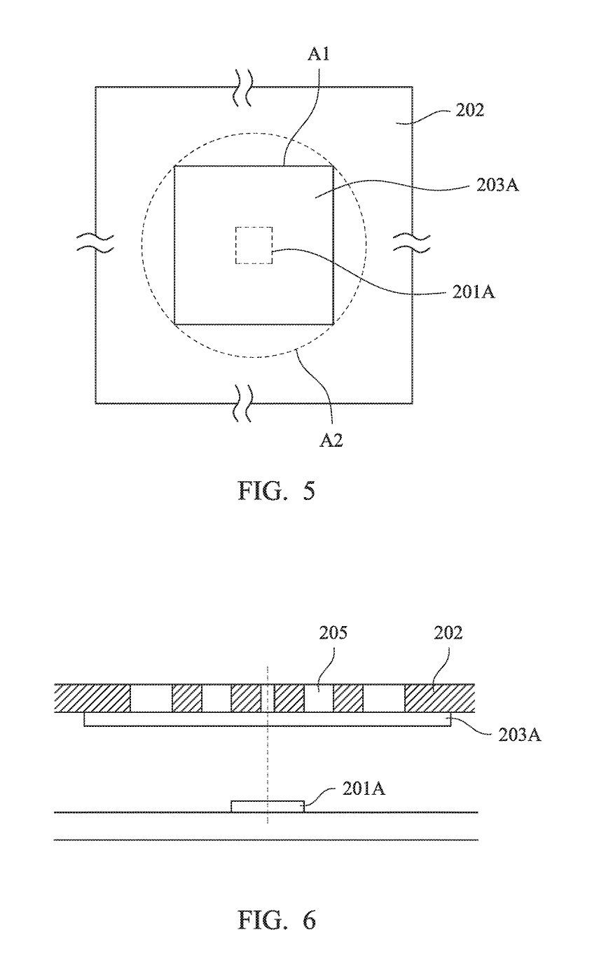

FIG. 5 is a schematic top view illustrating a part of FIG. 2. As shown in FIG. 5, the wavelength converting layer 203A entirely covers an orthographic projection area of the single color LED 201A on the optical control film 202. In an embodiment, the area of the wavelength converting layers 203A is A1, a light emitting area of the single color LED 201A on the optical control film 202 is A2. If A1 is smaller than A2, there will be less blue light converted into yellow light, which results in a lower backlight luminance, and the concentration of quantum dot of the wavelength converting layer 203A needs to be increased to improve the luminance efficiency. On the other hand, if Al is larger than A2, there will be more blue light converted into yellow light, which results in a higher backlight luminance, and the concentration of quantum dot of the wavelength converting layers 203A needs to be decreased to reduce the luminance efficiency.

If A1 is smaller than A2, there will be less blue light converted into yellow light and the back light module will have blue color shift. If A1 is larger than A1, there will be more blue light converted into yellow light and the back light module will have yellowish color shift. Therefore, in an embodiment, the backlight module with 0.78≦A1/A2≦0.91 will perform a uniformly white light without color shift. In an embodiment, each wavelength converting layer 203 is entirely separate from each other. Therefore, comparing to the conventional backlight module, this embodiment can produce uniformly white while using less wavelength converting materials.

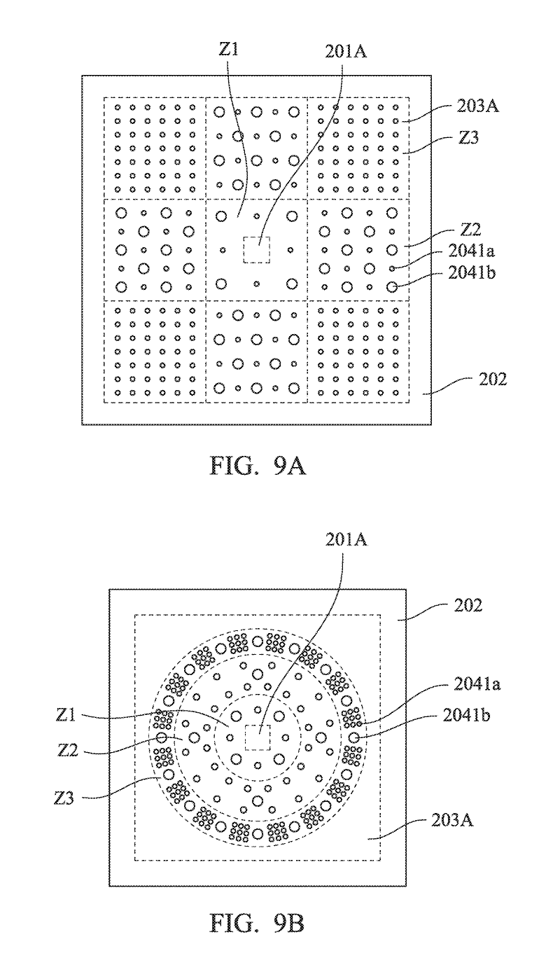

As shown in FIG. 2, in the zone of the optical control film 202 covered by the wavelength converting layer 203A, there is no through hole on the optical control film 202. In another embodiment, there are through holes 205 in the zone of the optical control film 202 covered by the wavelength converting layer 203A. As shown in FIG. 6, the closer to the position above the single color LED 201A the smaller opening area of the through holes 205 is. In other words, the diameter of the through holes 205 can be adjusted in accordance with the location of the holes with respect to the single color LED 201A. Alternatively, the through holes 205 residing in different areas of the optical control film 202 occupy different opening areas in the different zones, respectively, In an embodiment, as shown in FIG. 9A, the optical control film 202 covered by the wavelength converting layer 203A is virtually divided into a plurality of zones (e.g., Z1, Z2, Z3, etc.) and the shape of each zone is substantially rectangular. The zone may have a plurality of openings 2041a such as Zone Z3 as shown in FIG. 9A, or may have different-size openings 2041a and 2041b such as Z2 as shown in FIG. 9A. In the center Zone Z1, the opening area formed by the through holes 205 in the position above the single color LED 201A is smaller than the opening area formed by the through holes 205 far away the position above the single color LED 201A so that the total area of the opening area in the position above the single color LED 201A is smaller than the total opening area far away the position above the single color LED 201A. The total opening area formed by the through holes 205 in a zone of the optical control film 202 closer to the position above the single color LED 201A is smaller than the total opening area formed by the through holes 205 in another zone of the optical control film 202 farther away from the position above the single color LED 201A. Accordingly, illumination uniformity among the zones of the optical control film 202 covered by the wavelength covering layer 203A can be improved.

In an embodiment, as shown in FIG. 9B, the optical control film is virtually divided into few zones and the shape of each zone is substantially circle. The zone may have a plurality of openings 2041a shown or may have different-size openings 2041a and 2041b. In the center Zone Z1, the opening area formed by the through holes 205 in the position above the single color LED 201A is smaller than the opening area formed by the through holes 205 far away the position above the single color LED 201A so that the total area of the opening area in the position above the single color LED 201A is smaller than the total opening area far away the position above the single color LED 201A. The total opening area formed by the through holes 205 in a zone of the optical control film 202 closer to the position above the single color LED 201A is smaller than the total opening area formed by the through holes 205 in another zone of the optical control film 202 farther away from the position above the single color LED 201A. Accordingly, illumination uniformity among the zones of the optical control film 202 covered by the wavelength covering layer 203A can be improved. In other embodiments, the shape of wavelength covering layer 203 can be star, single square, multi-square or combination of thereof

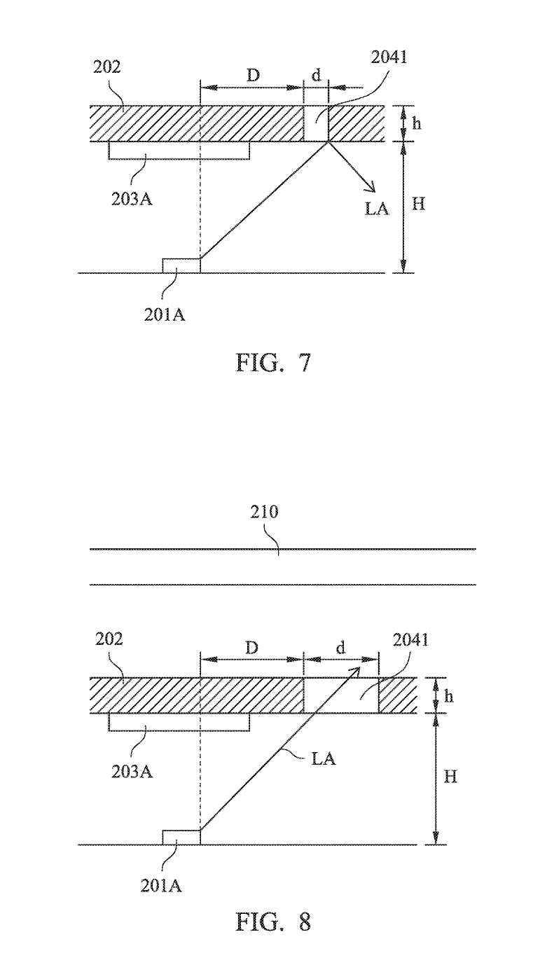

FIGS. 7 and 8 are schematic side views illustrating two embodiments. The optical control film 202 has a largest through hole 2041 among the through holes 204. The largest through hole 2041 has a diameter d. The horizontal distance between the largest through hole 2041 and the closest LED 201A is D. The vertical distance between the closest single color LED and the optical control film is H. The thickness of the optical control film is h. Because the light emitting area on the optical film is proportional to the vertical distance between the closest single color LED and the optical control film H, for a better conversion ratio, the area of the wavelength converting layer is larger than the light emitting. Consequently, the higher the vertical distance between the closest single color LED and the optical control film H, the larger the area of the wavelength converting layer is.

In an embodiment as shown in FIG. 7, when d<h(D/H), the light LA emitted from the single color LED 201A will not directly pass through the through holes 2041. Instead, the light LA will at least be reflected by reflective surface 2021 one time before passing through the through holes 2041. In another embodiment as shown in FIG. 8, when d>h(D/H), the light LA emitted from the single color LED 201A may directly pass through the through holes 2041. The light intensity of the light LA directly passing through the through holes 2041 may be too high and the backlight module will have uneven performance. To prevent this from happening, in an embodiment, the backlight module comprises an optical film 210 with a transmittance lower than 10%. The optical film 210 is disposed on the side of the optical control film 202 opposite to another side of the optical control film 202 where the single color LED 201A is located. The light with high intensity will be diffused by the optical film 210 and the backlight module will have uniform performance.

Compared with the prior art, the backlight module uses less wavelength converting materials in the present disclosure, and produces a uniformly white light without color shift.

Although the preferred embodiments of the present disclosure have been described herein, the above description is merely illustrative. Further modification of the disclosure herein disclosed will occur to those skilled in the respective arts and all such modifications are deemed to be within the scope of the disclosure as defined by the appended claims.

What is claimed is:

1. A backlight module, including:
a plurality of single color light-emitting diodes (LEDs);
an optical control film having a plurality of through holes, the optical control film being located above the plurality of single color LEDs, and
a plurality of wavelength converting layers disposed between the optical control film and the plurality of single color LEDs, wherein each of the wavelength converting layers corresponds to one of the single color LEDs and converts a light emitted from the one of the single color LEDs to white light.

2. The backlight module of claim 1, wherein the optical control film has a reflective surface facing a light emitting side of the plurality of single color LEDs.

3. The backlight module of claim 1, wherein each of the wavelength converting layers is a quantum dot layer.

4. The backlight module of claim 3, wherein a concentration of the quantum dot within an entire corresponding one of the wavelength converting layers is uniform.

5. The backlight module of claim 3, wherein the farther a distance away from the point of one of the wavelength converting layers directly above a corresponding one of the LEDs, the higher a transmittance of the one of the wavelength converting layers.

6. The backlight module of claim 3, wherein a concentration of the quantum dot in each of the wavelength converting layers is decreased along an increase of a distance away from a point of one of the wavelength converting layers directly above one of the single color LEDs.

7. The backlight module of claim 3, wherein the plurality of wavelength converting layers comprises a first wavelength converting layer and a second wavelength converting layer, an area of the first wavelength converting layer is larger than an area of the second wavelength converting layer, and a concentration of the quantum dot in the first wavelength converting layer is lower than a concentration of the second wavelength converting layer.

8. The backlight module of claim 3, wherein an area of each of the wavelength converting layers entirely covers an orthographic projection area of a corresponding one of the single color LEDs on the optical control film.

9. The backlight module of claim 3, wherein an area of each of the wavelength converting layers is A1, a light emitting area of a corresponding one of the single color LEDs on the optical control film is A2, and 0.78≦A1/A2≦0.91.

10. The backlight module of claim 1, wherein each two immediately adjacent wavelength converting layers are entirely separate from each other.

11. The backlight module of claim 1, wherein in a zone of the optical control film covered by a corresponding one of the wavelength converting layers, an area percentage of the through holes in the zone of the optical control film in a position closer to above the one of the single color LEDs is smaller than an area percentage of the through holes in the zone of the optical control film in a position farther away from the one of the single color LED.

12. The backlight module of claim 1, wherein a largest through hole among the through holes has a diameter d, a horizontal distance between the largest through hole and a closest one of the single color LEDs is D, a vertical distance between the closest one of the single color LEDs and the optical control film is H, a thickness of the optical control film is h, and d<h(D/H).

13. The backlight module of claim 1, further comprising an optical film with a transmittance lower than 10% and disposed on a side of the optical control film opposite to another side of the optical control film where the single color LEDs are located, wherein the optical control film has through holes, a largest diameter of the through holes is d, a distance between the the single color LED and the largest through hole is horizontal D, a distance between a bottom of the the single color LED and the optical control film is vertical H, a thickness of the optical control film is h, and d>h(D/H).

14. The backlight module of claim 1, wherein at least two of the plurality of single color LEDs have different colors from each other.
